(19) United States
(12) Patent Application Publication
(10) Pub. No.: US 2009/0199721 A1
(43) Pub. Date: Aug. 13, 2009

(54) Single cup coffee brewer

(76) Inventor: Robert W. Hausslein, Lexington, MA (US)

Correspondence Address: BERNARD J. LACOMIS, 137 BINGHAM RD., CARLILSE, MA, 01741, US

(21) Appl. No.: 12/321,204

(22) Filed: Jan. 20, 2009

Related U.S. Application Data
(60) Provisional application No. 61/011,917, filed on Jan. 22, 2008.

(51) Int. Cl. A47J 31/38; A47J 31/02; A47J 31/24

(52) U.S. Cl. 99/302 R; 99/289 R; 426/433

(57) ABSTRACT

A single cup brewer for use in brewing coffee or the like with water in the cup. The brewer comprises a chamber formed by a deformable elastic cover and a base, the cover being attachable to and detachable from the base to form the chamber. The base is adapted to rest on the cup and to support a filter for supporting the coffee within the chamber. The user successively deforms and releases the cover to cause water in the cup to move repeatedly from the cup through the filter and coffee into the chamber and back to the cup again to complete the brewing process.

### CROSS-REFERENCE TO RELATED PATENT APPLICATIONS

This application claims the benefit of Provisional Patent Application Ser. No. 61/011,917, filed on Jan. 22, 2008, the disclosure of which is incorporated in its entirety hereinto by reference.

### BACKGROUND OF THE INVENTION

It has long been desired to provide a quick and easy method and apparatus to brew a single cup of coffee in a similar way to brewing a single cup of tea using an infusion bag. However, it is well known that simply putting ground coffee into an infusion bag, such as a tea bag, and immersing it in a cup of hot water extracts the coffee very slowly. Even dragging the bag back and forth does not move water through the interior of the bag fast enough to percolate through the mass of ground coffee particles in a reasonable time. Entrapped air also hinders the penetration of water significantly. Nevertheless, single cup infusion bags of coffee are currently being sold. However, these infusion bags contain, in addition to ground coffee, a considerable fraction of soluble coffee, also known as instant coffee. The soluble fraction is extracted relatively quickly. Soluble coffee is generally considered to produce an inferior beverage.

Prior art attempts using hand driven methods to speed up the extraction of ground coffee by forcibly moving water through infusion bags and other porous chambers containing ground coffee provide insufficient flow rate either into the chamber or out of the chamber or both. The more successful attempts have been based on electrically powered motorized countertop brewers, which greatly complicate and add significant cost to the brewing process.

It is therefore a main object of the invention to provide a hand driven single cup coffee brewer which is simple in makeup and construction, low in cost and easy to use.

A further object is to provide a single cup coffee brewer which operates to put the hot water used in brewing under pressure in order to increase its rate of flow as it passes through the ground particles of coffee.

A yet further object of the invention is the provision of a single cup brewer which operates in conjunction with hot water preloaded into a single cup or mug to pump the water from the cup into a brewing chamber and put it under pressure to increase its rate of flow during its passage through the coffee particles.

A still further object of the invention is to provide an apparatus for repeatedly recycling partly brewed coffee through the brewing chamber a selected number of times to successively increase the strength of the resultant coffee brew.

A further object is to provide an apparatus suitable for the above purposes that is simple to use, clean and store in a typical kitchen drawer or office desk drawer.

### BRIEF SUMMARY OF THE INVENTION

The above noted and other objects of the invention are accomplished by a brewer comprising a brewing chamber adapted to rest on the rim of a cup or mug to allow a user manually to pump hot water from the cup into and out of the brewing chamber and through coffee particles located in the path of the circulating water. The objects of the invention are also accomplished by the associated method. The brewer in turn includes an elastic cover that is attachable to and detachable from a base to close and open the brewing chamber for cleaning and recharging with fresh ground coffee. A filter is supported on the base in a manner such that when the chamber is open the user may insert coffee grains into the chamber on the filter. The base also includes an opening below the filter which is coupled to a dip tube that extends into the hot water in the cup when the base rests on the rim of cup. When the base is resting on the cup and the elastic cover is attached to the base (thereby closing the chamber), downward manual pressure on the cover moves fluid from the chamber, through the filter, and into the cup through the opening and dip tube. Release of the cover allows it to return to its previous shape to move water from the cup, through the dip tube and opening and filter back into the chamber for a repeat of the process upon subsequent pumping of the elastic cover.

Variants of the invention include means for altering the circulation of liquid in the brewer by means of valves and by means of controlling the resistance to flows in the various directions through the brewer, means for pivoting the dip tube, and means for employing pre-manufactured coffee pods in the brewer.

### BRIEF DESCRIPTION OF THE SEVERAL VIEWS OF THE DRAWINGS

A complete understanding of the present invention will be had by reference to the accompanying drawings, when considered in conjunction with the subsequent, detailed description, in which:

FIG. 1 is a sectional view of the brewer of the invention holding ground coffee resting on top of a cup also shown in section holding hot water used in the brewing process;

FIG. 2 is a sectional view, similar to FIG. 1, showing an alternative construction for the base of the brewer;

FIG. 3 is a sectional view, similar to FIG. 2, showing an additional alternative valve construction for the base of the brewer of the invention;

FIG. 4 is a sectional view of a pivotal dip tube for use in the brewer of the invention;

FIG. 5 is a sectional view of a removable filter basket inserted in a modified base;

FIG. 6 is a sectional view of the brewer containing a coffee pod and adaptor for use with the pod; and

FIG. 7 is a top view of the base holding a coffee pod adaptor and pod.

### DETAILED DESCRIPTION OF THE INVENTION

Referring to FIG. 1, there is shown an infusion device or brewer 10 suitable for brewing a single cup of coffee, tea, cocoa, herbs, seasonings, and the like. The brewer 10 comprises a base 13 and a cover 25. The cover 25 comprises a deformable dome 12 held within an annular retaining ring 14 The deformable dome 12 is preferably an elastomer that retains its elasticity in hot water and is a poor conductor of heat. The elastomer is a natural or synthetic rubber, preferably silicone rubber because of its substantial temperature insensitivity over the temperatures encountered. Alternatives to a deformable elastomer include a bellows or a piston/cylinder arrangement. The circular in cross-section cover 25 is attachable to and detachable from the base 13 by means of one of several well known complimentary formations 15, such a threads or the like, on the base 13 and the retaining ring 14. Other fastening means such a snap fits, bayonet lugs, hinged lids, or similar coupling means may be used.

The base 13 also supports a circularly shaped filter 21 by means of a multiplicity of cone shaped or pointed bosses 22 rising from the floor 23 of the base into contact with the underside of the filter. The bosses 22 collectively form a low-pressure-drop pathway or network of channels for the bidirectional flow of fluid to and from the brewing chamber 11, which is the volume bounded by the interior of the cap and the interior of the base above the filter. The brewing chamber 11 may be opened to expose its interior by unscrewing the cover 25 from the base 13. The base 13 also includes an opening 26 there through which is coupled to a dip tube or similar elongated conduit 24. The dip tube 24 extends from the base to below the surface of the water in the cup 20 and is fluidically connected to the pathway formed by the bosses 22 located below and adjacent the underside of the filter 21. For clarity, ground coffee 27 is shown on the filter 21 within the brew chamber 11.

The base 13, the retaining ring 14, and the dip tube 24 are made of suitable plastic or filled plastic that maintains adequate stiffness in contact with hot water, such as polypropylene, ABS, SAN, and polycarbonate.

It is desirable that the brewer 10 of the invention be easily stored in a kitchen drawer of shallow depth and, for this purpose, the dip tube is preferably pivotable to a position flat against the underside of the base 13 for compactness and further to permit ground coffee to be scooped into the chamber 11 when the base is not resting on a cup.

FIG. 4 shows, in section, a pivotable dip tube 50 which may be used with the brewer of the invention. The pivotable dip tube 50 and its connection to a modified base 51 are shown as viewed from the right side of the device. The dip tube and modified base are shaped so as to permit relative rotation of the elongated tube 50 from a position perpendicular to the plane of the base 51 to a position substantially parallel to the plane of the base. An O-ring 52 is employed as a sealing surface against which the dip tube 50 is rotated. An exemplary pivotable tube is of the type used in dispensing caps for lotions and creams currently on the market, and specifically, as used in the cap of the Rubbermaid Litterless Juice Box Model 3115. As an alternative to being pivoted, the dip tube may be designed to be collapsed, folded, telescoped, or simply removed.

Examples of suitable filter media include woven monofilament cloth, wire cloth, fabric (both woven and non-woven), filter paper, and porous plastic, metal and ceramic. Fragile and flexible filters may need support on their upper and lower surfaces. The filter 21 may be permanently attached to the base as in FIG. 1 or it may be removable, as shown in FIG. 5, where it is part of a basket 63 consisting of a supporting ring 60 attached to the periphery of the filter 21 itself, plus stiffening members 61 attached to the underside of the filter and to the supporting ring. The base 13 for the removable filter basket 63 does not need bosses rising from its floor because the stiffening members 61 additionally provide the space under the filter for fluid flow.

A preferred filter medium is fine woven screen, whether made of metal, ceramic, or fabric. The screen should have a finer mesh (smaller openings) than the screens that are commonly used with such coffee brewing devices as plunger pots (French presses) and drip coffeemakers, whether of the cone or basket type. The finer mesh is preferable because, unlike plunger presses and drip brewers in which the bed of coffee particles, once formed, is self-filtering to a significant degree, in the embodiments of the current invention shown in FIGS. 1 and 5, the bed is repetitively stirred up and reformed, providing greater opportunity for fine particles to be rinsed through the screen. Moreover, for all the embodiments of the current invention the loading of ground coffee per unit area of screen is lower than it is typically in plunger presses and drip brewers. The lower loading allows faster filtration but also provides more opportunity for fine particles to pass through. In a prototype of the current invention, a screen having 0.001 inch holes showed comparable pass through of fines as a screen having 0.01 inch holes used in the conventional manner in a drip brewer. A source of suitable filter material is Sefar America Inc.

In operation, the brewer 10 in FIG. 1 is first cleaned and readied for reuse by unscrewing the cover 25 from the base 13, discarding any coffee grounds that may be remaining in the chamber 11 from prior use, and rinsing the interior of the chamber 11 and base. The chamber 11 is charged by scooping or pouring loose ground coffee onto the top of filter 21 and the cover 25 is screwed back on the base to close the brewing chamber 11. The brewer 10 is then rested on a cup of hot water with the base resting on the rim 17 of the cup such that the dip tube is inside the cup.

The brewing process then begins by simply pushing down on the cover 12 or by gripping the brewer with both hands, thumbs on the cover, fingers under the lip of the base 13. To provide more area for finger contact, the base or cover may be designed to have side extensions (not shown).

In operation, the first squeeze or push down of the elastically deformable dome 12 expels air from the chamber 11, through the bed of coffee, filter, opening 26 and dip tube 24 into the cup of water. Upon release of the dome, water is sucked up into the dip tube, distributed to and through the interconnected passages formed by the upstanding bosses adjacent the underside of the filter, and passes through the filter into contact with the ground coffee particles. As the water flows into contact with the coffee particles, it disrupts the coffee bed and suspends coffee particles in the water accumulating in the chamber 11. It would be preferable for the user to allow the particles to dwell, suspended in the water for a short time while they settle by gravity back onto the filter. The second squeeze of the cover 12 by the user forces the liquid in the reverse direction, from the brew chamber 11 back into the cup. The coffee particles, now partially extracted by their temporary suspension in the hot water in the chamber, are reformed into a bed of substantially uniform depth on the dome side of the filter as the water is re-circulated back to the cup through the coffee bed and the network of passages beneath the filter. The second release of the dome by the user draws partially brewed coffee from the cup back into the brew chamber, again disrupting the bed of particles into suspension, thereby furthering the flavor extraction process, which process is enhanced as the successive cycles are performed.

Additional squeeze/release cycles increase the strength of the brewed coffee. When the desired strength is reached, the device is lifted away from the cup followed by an optional squeeze or two of the dome to discharge any residual liquid from the chamber 11 into the cup.

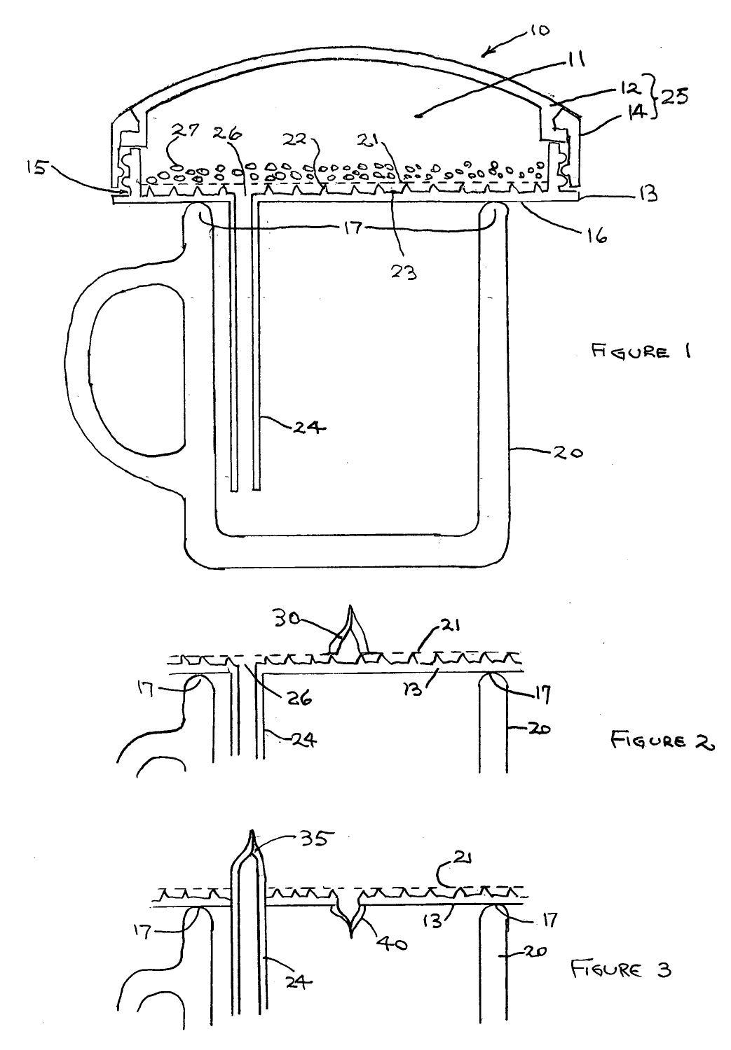

In a variant of the above described device, conceptually shown in FIG. 2, the rate of liquid intake from the cup is increased by partially bypassing the filter with a less restricted fluid pathway as by the use of a check valve 30 which allows faster recovery of the dome 12 to its undeformed shape. In this variant, the pathway contains a check valve 30 which, in addition to allowing water to pass more easily from the cup to the chamber, also reduces the rate of outflow of water from the chamber during squeezing. Although a duckbill check valve is shown in FIG. 2, alternatives include flapper valves, umbrella valves, and ball check valves.

The bypass is particularly advantageous with filters having small holes which tends to restrict the flow of air when wetted. For such wetted filters, a critical pressure drop, known as the bubble point, is required to begin the flow of air (or other gas). The smaller the holes in the filter, the larger the pressure drop required. This effect comes into play in the current invention during the final discharge of liquid, referred to above, when the device is lifted from the cup and squeezed a few times. Air is sucked in to replace the discharged liquid. With screens having the small holes (e.g., 0.001 inch) as preferred, the incoming air will tend to be blocked by the wetted filter screen, resulting in the device being effectively “airlocked”. The bypass avoids this airlocking.

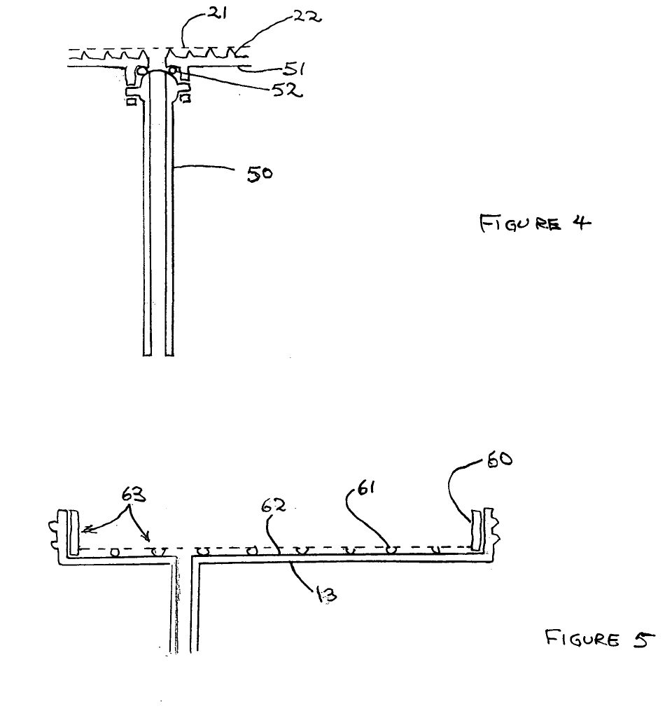

Another variant, shown in FIG. 3, employs two check valves 35 and 40 to enable full separation of the intake and discharge pathways. By so doing, the discharge pathway is not immersed in the cup. Specifically, the air or liquid discharged from the chamber through the dip tube and into the body of the liquid on the squeeze portion of the brewing cycle in the apparatus of FIG. 1, is instead discharged above the surface of the liquid in the cup through the valve 40, thereby eliminating the possibility of liquid overflowing the cup during the first squeeze when air expelled from the device can bubble up vigorously if discharged below the surface of the liquid. The two check valve variant shown in FIG. 3 promotes unidirectional flow by reducing remixing of the bed, thereby permitting the use of filter screens with larger holes.

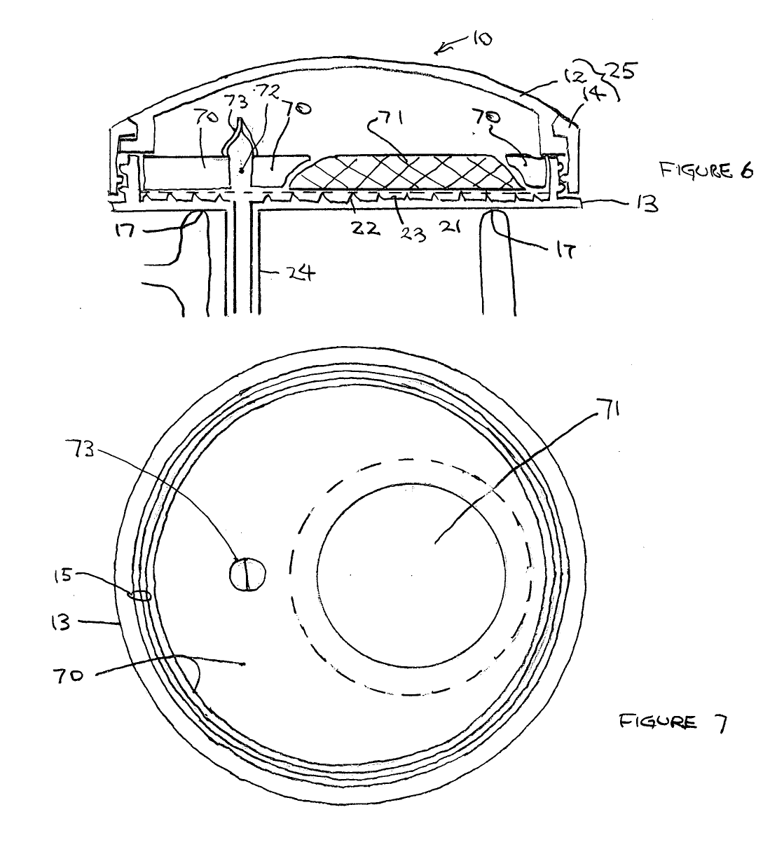

Other variants may be designed for use with pre-manufactured single serve coffee pods, in which a predetermined amount of ground coffee, typically about 8 grams, is sandwiched between two layers of filter paper laminated at their edges to form a circular lip around the rim of the pod. The pods are intended for use in companion motorized electrical appliances that pump hot water through them into the user's cup. If one of these pods is simply loaded into one of the above embodiments of the current invention in place of a corresponding amount of loose ground coffee, brewing will be inefficient because water will significantly bypass the pod. Bypassing can be reduced by using an adaptor in the base or cover that seals around the outer periphery of the pod and thereby forces water in the chamber through the pod, as shown in FIGS. 6 and 7. FIG. 6 is otherwise identical to FIG. 1 except for the replacement of the loose coffee grounds 27 with the coffee pod adaptor 70 and the coffee pod 71. The adaptor is made of plastic or preferably closed cell elastomeric foam. It is held against the pod 71 and the base 16 by the cover 25. The inflowing liquid from the cup passes into the chamber through the hole 72 and the open one-way valve 73 in the adaptor 70. Exiting liquid leaving the chamber would be blocked from flowing back through the hole 72 by the check valve 73 to force water from the chamber through the coffee in the pod on its return to the cup.

The embodiment shown in FIGS. 6 and 7 may be further modified for use with pods only, not for use with loose ground coffee, by replacing the filter screen with a less costly, more open support filter screen having much larger holes i.e., of the order of 0.125 inches.

The preceding description has presented in detail an exemplary preferred embodiment of the invention and its application. While the description has been primarily directed to brewing coffee with the described apparatus, it should be clear to those skilled in the art that it is equally suitable for making flavorful beverages/drinks, such as tea, seasonings and the like, from other solid particulate material by the same or similar processes and apparatus as shown herein. Those skilled in the art will therefore recognize that numerous alternatives encompassing many variations may readily be employed without departing from the scope of the present invention as set forth in the claims herein.

What is claimed is:

1. A brewer for use with a cup containing hot water for brewing a cup of coffee comprising,
a chamber for holding coffee solids to be brewed, said chamber formed by a deformable elastic cover and a base, the cover being attachable to and detachable from said base to close and open said chamber respectively, said base adapted to rest on the rim of said cup and to support a filter with openings sufficiently small to prevent solids below a pre-selected size to pass there through, said base including an opening, the opening being coupled to a tube adapted to extend into the water when the base is resting on said cup, the chamber when closed and resting on said cup adapted to permit a user to manually deform said cover to reduce the volume of said chamber and thereby move water from said chamber through said filter, opening and tube into said cup, then to release said cover to permit withdrawal of fluid from said cup, through said tube and opening and through said filter into said chamber, and to then repeat the process as needed, whereby a cup of coffee is brewed to a selected strength by the user.

2. The brewer of claim 2 a one way valve located in said opening to bypass a portion of the water from said cup directly to said chamber without flowing through said filter.

3. The brewer of claim 1 wherein two one way valves are arranged to ensure unidirectional flow of liquid from the cup to the ground coffee to the filter and back to the cup.

4. The brewer of claim 1 further including means for moving the tube between two positions, a first position running substantially parallel with the walls of said cup when the brewer is resting on said rim, and a second position wherein the tube is substantially in parallel to the plane of said base.

5. The brewer of claim 1 further including formations located between said base and filter to direct water entering said base along substantially the entire surface of said filter.

6. The combination recited in claim 1 including formations located between said base and filter to disrupt the bed of solids on said filter into suspension in said chamber.

7. A method of brewing a single cup of coffee comprising the steps of:
a) providing hot water in said cup,
b) providing a brewing chamber comprising an deformable cover and a base, said cover attachable to and detachable from said base to close and open said chamber respectively, said base adapted to rest on the rim of said cup, said base supporting a filter and including an opening and conduit located on the side of the filter remote from the cover; said conduit extending away from said base;
c) opening said chamber to insert coffee solids onto said filter,
d) closing said chamber;
e) positioning said closed chamber on the rim of said cup;
f) compressing said cover to pump water from said chamber, through said coffee and filter, and through said opening and conduit into said cup, and;
g) releasing said cover to force liquid from said cup, through said conduit and opening, through said filter into said chamber;
whereby repeated compressions and releases of said cover result in the passage of water into repeated contact with said solids to produce a cup of coffee of a strength controllable by the number of pumping cycles.
